(19) United States
(12) Patent Application Publication
(10) Pub. No.: US 2026/0021016 A1
(43) Pub. Date: Jan. 22, 2026

(54) MASSAGE THERAPY DEVICE

(71) Applicant: Bradley CARDEN, Manly Vale (AU)

(72) Inventor: Bradley CARDEN, Manly Vale (AU)

(21) Appl. No.: 19/275,249

(22) Filed: Jul. 21, 2025

(30) Foreign Application Priority Data
Jul. 22, 2024 (AU) 2024902270

(51) Int. Cl. A61H 15/02; A61H 23/02

(52) U.S. Cl. CPC A61H 15/02; A61H 23/0263; A61H 2201/0188; A61H 2201/5035; A61H 2201/5084; A61H 2201/5097

(57) ABSTRACT

A massage therapy device includes a tubular case, lights configured to emit light from the tubular case, and an internal framework supporting the tubular case. The device is designed to be rolled against the body for deep tissue massage, enhanced by therapeutic light emission. The tubular case may feature a transparent non-rigid sleeve enveloping a transparent rigid tube, with the internal framework preventing substantial flexing and bending during use. The device may also include lenses interfacing the lights and the tubular case, ensuring effective light emission, and may be powered by an internal battery compartment with a removable battery.

### FIELD OF THE INVENTION

This disclosure relates generally to massage therapy devices. More specifically, it pertains to a device that combines mechanical massage with therapeutic light emission, designed to provide enhanced therapeutic benefits through a lightweight, durable, and easy-to-use construction.

### BACKGROUND OF THE INVENTION

Massage therapy devices have long been used for their therapeutic benefits, including relief of muscle tension, pain reduction, and overall relaxation. Traditional massage therapy methods often rely on manual techniques, which can vary significantly in effectiveness due to differences in practitioner skill and consistency. To address these challenges, various mechanical massage devices have been developed to provide more consistent and targeted therapeutic effects.

One common type of massage device includes rollers that are designed to be rolled against the body to provide deep tissue massage. These devices can be used at home or in professional settings, offering a convenient way to achieve muscle relief without the need for a massage therapist. While effective, these devices often have limitations in terms of their ability to deliver consistent pressure and therapeutic benefits across different parts of the body.

In recent years, there has been an increased interest in integrating light therapy with massage devices. Light therapy, particularly using specific wavelengths of light such as red and infrared, has been shown to have various therapeutic effects, including improved circulation, reduced inflammation, and enhanced tissue repair. Devices that combine massage and light therapy aim to provide enhanced therapeutic benefits by simultaneously delivering mechanical and photonic stimulation to the body.

Despite the advancements in massage therapy devices, there remain challenges in creating devices that are both lightweight and durable, while also providing effective therapeutic light emission. Balancing these factors is crucial for developing a device that is comfortable to use and delivers consistent therapeutic results. Additionally, ensuring the device can be easily powered and controlled adds another layer of complexity to the design and functionality of modern massage therapy devices.

### SUMMARY OF THE DISCLOSURE

A massage therapy device is provided, comprising a tubular case, lights configured to emit light from the tubular case, and an internal framework supporting the tubular case. The lights are preferably configured to emit therapeutic light within the range of 600 to 1100 nm, enhancing the therapeutic benefits. The tubular case is designed to be rolled against the body for deep tissue massage, which is enhanced by the emitted light. The tubular case may comprise a transparent non-rigid sleeve enveloping a transparent rigid tube, where the non-rigid sleeve is preferably made of silicone for an ergonomic, comfortable, and slightly deformable skin-contacting interface. The rigid tube may be made of polycarbonate to provide additional support.

The internal framework prevents substantial flexing and bending of the tubular case during use, ensuring durability and effectiveness. The non-rigid sleeve and the rigid tube may have a thickness of less than 2 mm to reduce the overall weight of the device, making it easier to handle. The lights may be configured to emit light radially from the tubular case for uniform coverage. Additionally, the device may comprise lenses interfacing the lights and the tubular case, with the lenses preferably being flat-faced to press flat against the internal surface of the tubular case.

The internal framework may include a series of frames arranged along the length of the device, supporting a series of longitudinal rigid support rods. These support rods may include longitudinally oriented flanges resistant to bending, providing further structural integrity. The frames may define aligned notches supporting respective support rods, ensuring proper alignment and stability. Flat-faced lenses interfacing the support rods and the tubular case may form part of the internal framework.

The support rods may have LEDs mounted on exterior surfaces and be electrically connected to a power supply, allowing for efficient operation of the lights. At least one end cap may define sockets within which respective ends of the support rods are inserted and engaged, securing the internal framework within the tubular case.

An internal battery compartment and a removable battery configured to insert into the internal battery compartment may be included for power supply. The removable battery may have an external power button operative to control the lights and other functions of the device. Coaxial electrical connectors may be defined by the removable battery and the internal battery compartment, allowing for easy replacement and alignment. A twist lock mechanism may be included to prevent dislodgement of the battery from the battery compartment, ensuring secure and reliable operation. The battery compartment may occupy most of the width and length of the device, maximizing the interior volume available for the removable battery.

An electronics compartment may be longitudinally aligned with the battery compartment, housing various power supply and control electronic PCBs. A controller installed within the electronics compartment may control the lights, with capabilities to adjust the intensity and operation of the lights according to a mode of operation. The mode of operation may be specified by a target muscle group, allowing for tailored therapeutic treatments.

The controller may interface with an accelerometer to determine the orientation of the device and independently control the lights accordingly, ensuring optimal performance. A wireless transceiver may be included to receive control instructions and transmit data, enhancing user interaction and monitoring. The controller may measure dosage based on the operational duration and intensity of the lights, transmitting this information via the wireless transceiver to a recipient electronic device.

A vibrator may be installed to oscillate the tubular case, providing additional therapeutic benefits. This vibrator may comprise an electric motor turning an eccentric flywheel and may be installed within a separate electronics compartment adjacent to the battery compartment. The tubular case may comprise an intake grille and an exhaust grille for cooling airflow, with an impeller adjacent to the intake grille to facilitate airflow. This impeller may be a centrifugal impeller located within an electronics housing adjacent to the intake grille, with the electronics housing comprising vents for the escape of airflow further into the interior of the device. This cooling system helps dissipate heat generated by high-intensity lights, ensuring the device operates efficiently and safely.

According to one aspect, there is provided a massage therapy device comprising a tubular case, lights configured to emit light from the tubular case, and an internal framework supporting the tubular case.

In embodiments, the lights are configured to emit therapeutic light within the range of 600 to 1100 nm. The lights may be configured to emit light radially from the tubular case.

In embodiments, the tubular case is designed to be rolled against the body for deep tissue massage. The tubular case may comprise a transparent non-rigid sleeve enveloping a transparent rigid tube. Preferably, the non-rigid sleeve is made of silicone and the rigid tube is made of polycarbonate. The non-rigid sleeve and the rigid tube may each have a thickness of less than 2 mm. The internal framework may prevent substantial flexing and bending of the tubular case during use.

The device may further comprise lenses interfacing the lights and the tubular case, the lenses preferably being flat-faced to press flat against the internal surface of the tubular case.

In some embodiments, the internal framework comprises a series of frames arranged along the length of the device, supporting a series of longitudinal rigid support rods. The frames may define aligned notches supporting respective support rods and may comprise longitudinally oriented flanges resistant to bending. Flat-faced lenses may interface the support rods and the tubular case. The support rods may have LEDs mounted on exterior surfaces and be electrically connected to a power supply. At least one end cap may define sockets within which respective ends of the support rods are inserted and engaged.

According to certain embodiments, the device comprises an internal battery compartment and a removable battery configured to insert into the internal battery compartment. The removable battery may have an external power button operative to control the lights. The removable battery and the internal battery compartment may define coaxial electrical connectors, and preferably a twist lock mechanism is provided to prevent dislodgement of the battery from the battery compartment. The battery compartment may occupy most of the width and length of the device.

The device may further comprise an electronics compartment longitudinally aligned with the battery compartment. A controller may be installed within the electronics compartment, configured to control the lights. The controller may be configured to control at least one of the intensity and operation of the lights according to a mode of operation, which may be specified by a target muscle group.

The controller may interface with an accelerometer configured to determine the orientation of the device and independently control the lights accordingly. The controller may further interface with a wireless transceiver configured for wirelessly interfacing an electronic device. In such embodiments, the controller may be configured to receive control instructions via the wireless transceiver, such instructions optionally specifying a mode of operation. The controller may also be configured to transmit data via the wireless transceiver. In particular, the controller may measure dosage according to at least one of the operational duration and intensity of the lights and transmit a dosage measurement via the wireless transceiver.

In further embodiments, the device may comprise a vibrator installed to oscillate the tubular case. The vibrator may comprise an electric motor turning an eccentric flywheel, and may be installed within a separate electronics compartment adjacent to the battery compartment.

The tubular case may further comprise an intake grille and an exhaust grille at opposite ends thereof for cooling airflow. An impeller may be provided adjacent to the intake grille, the impeller preferably being a centrifugal impeller. The impeller may be located within an electronics compartment adjacent to the intake grille, and the electronics compartment may comprise vents for the escape of airflow further into the interior of the device.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a cross-sectional view of the massage therapy device 100, showing the tubular case 101, lights 102 configured to emit therapeutic light from the tubular case 101, and the internal framework supporting the tubular case 101.

FIG. 2 shows a disassembled cross-sectional view of the device 100.

FIG. 3 shows an external nonrigid sleeve 103 of a tubular case 103 of the device 100.

FIG. 4 shows an internal rigid tube of the tubular case 101 configured to support the nonrigid sleeve 103.

FIG. 5 shows a series of rows of lights 102 on support rods 108 capable of emitting light radially from the tubular case 101. It also illustrates lenses 106 interfacing between the lights 102 and the tubular case 101.

FIG. 6 shows a view of the internal framework defined by a series of generally circular frames 107 arranged along the length of the device 100, supporting a series of longitudinal rigid splines 108 shown in FIG. 5 with electrical connections for the lights 102.

FIG. 7 shows an end cap 124 and removable battery 112 of the device 100 in accordance with an embodiment.

### DESCRIPTION OF EMBODIMENTS

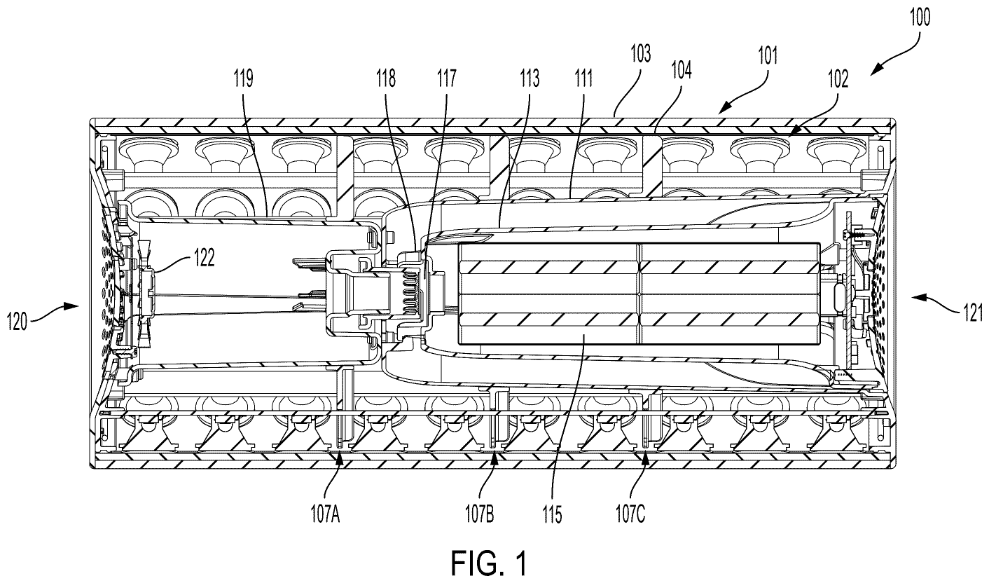

FIG. 1 shows a cross-sectional view of a massage therapy device 100. The device defines a tubular case 101, lights 102 configured to emit therapeutic light (such as red and/or infrared light within the therapeutic range of 600 to 1100 nm) from the tubular case 101, and an internal framework supporting the tubular case 101.

The tubular case 101 is designed to be rolled against the body for deep tissue massage, enhanced by the therapeutic light. The internal framework supports the tubular case 101 against the significant pressure applied thereto (including when the massage device 100 is rolled between a floor surface and the body), yet allows for a relatively lightweight construction.

The tubular case 101 may be defined by a transparent non-rigid sleeve 103 enveloping a transparent rigid tube 104. The non-rigid sleeve 103 may be made of silicone to provide an ergonomic, comfortable, and slightly deformable skin-contacting interface, supported by the internal rigid tube 104, which may be made of polycarbonate.

The internal rigid tube 104 is further supported by the internal framework, thereby preventing substantial flexing and bending of the tubular case 101 in use. Preferably, the non-rigid sleeve 103 and the rigid tube 104 are kept as thin as possible to reduce the overall weight of the device 100, hence the need for the internal framework supporting the tubular case 101. In embodiments, the non-rigid sleeve 103 and the rigid tube 104 may have a thickness of less than 2 mm. In alternative embodiments, the tubular case 101 may be defined by a semi-rigid rubber tube, also configured to provide a lightweight construction for the device 100.

With reference to FIG. 5, the device 100 may comprise a series of rows of lights 102 capable of emitting light radially from the tubular case 101. Lenses 106 may interface between the lights 102 and the tubular case 101. The lenses 106 may be flat-faced to press flat against the internal surface of the tubular case 101.

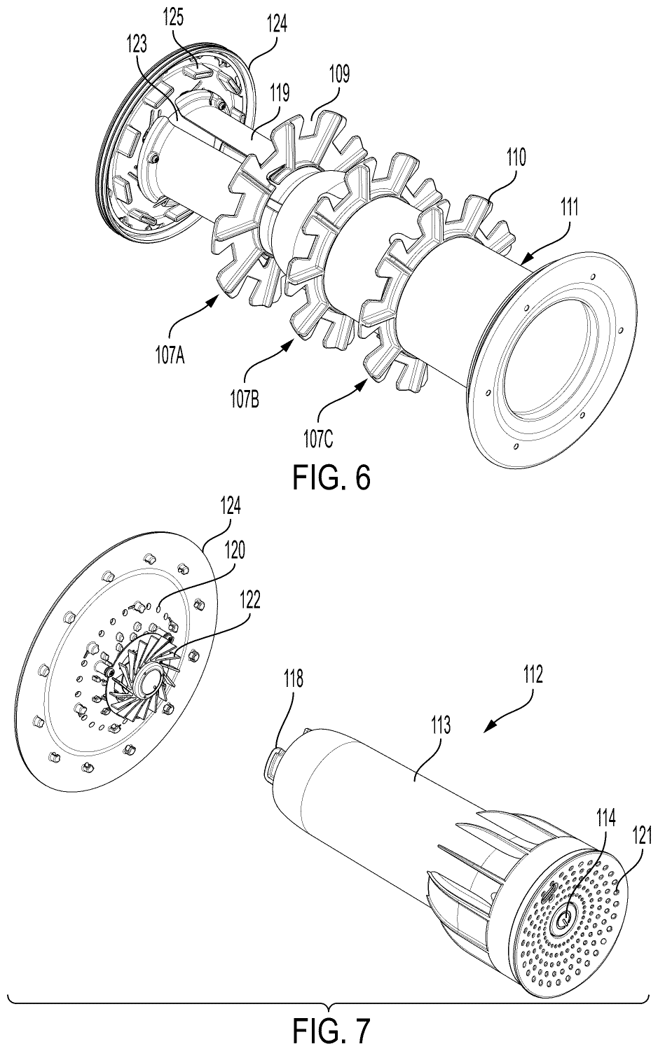

With further reference to FIG. 6, the internal framework may be defined by a series of generally circular frames 107 arranged along the length of the device 100, supporting a series of longitudinal rigid support rods 108, which have electrical connections for the lights 102. The support rods 108 are preferably planar. The support rods 108 may have red and/or infrared-emitting LEDs mounted on exterior surfaces and electrically connected to a power supply. Peripheral edges of the frames 107 may define a series of notches 109 in alignment to support respective support rods 108. The frames 107 may comprise longitudinally oriented flanges 110 resistant to bending. In the embodiment shown, the device 100 comprises three frames 107: a central frame 107B and a pair of lateral frames 107A and 107C.

At least one end cap 124 of the device may define sockets 125 within which respective ends of the support rods are inserted and engaged.

As such, the frames 107 internally support the support rods 108, which have the flat-faced lenses 106 that press in turn against the interior surfaces of the tubular case 101, providing a relatively rigid yet lightweight internal framework supporting the tubular case 101 against flexing and bending in use. This configuration also allows the internal framework with the lights 102 installed to slide into the tubular case 101 during assembly.

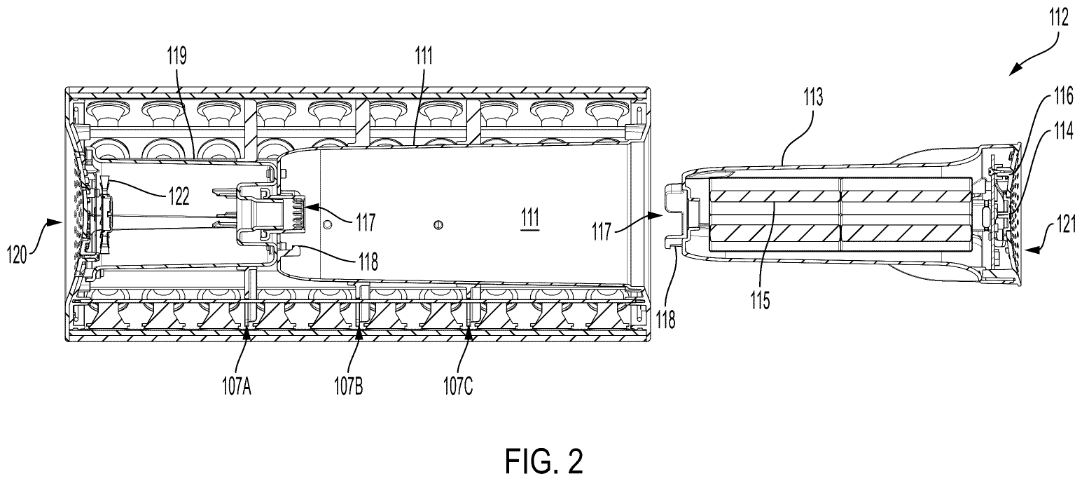

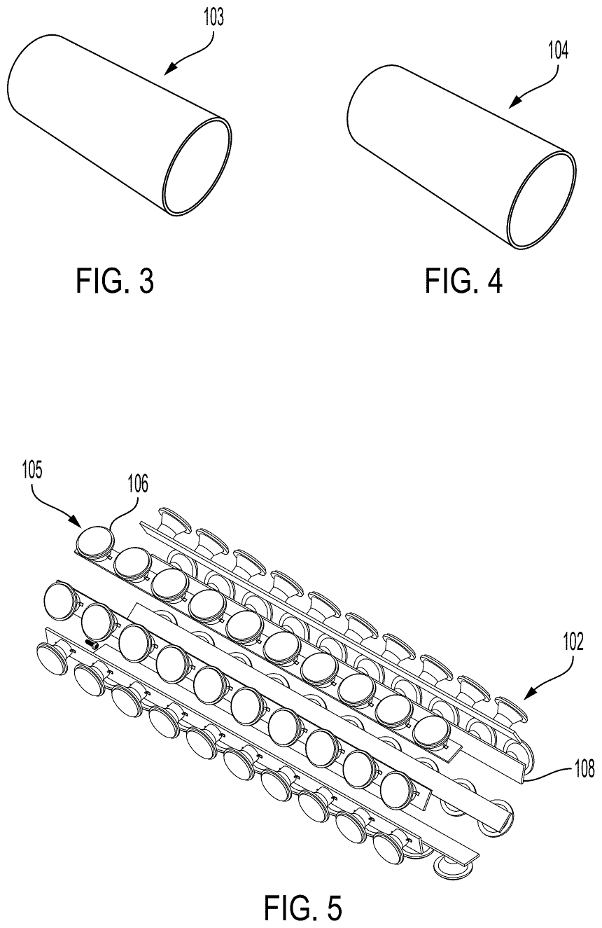

The device 100 may further comprise an internal battery compartment 111 and a removable battery 112, configured to insert into the internal battery compartment 111 through one end of the device 100, as illustrated in FIGS. 1 and 2. As can be appreciated from FIG. 2, the internal battery compartment 111 may occupy most of the cross-section and length of the device 100, thereby maximising the interior volume available for the removable battery 112. The removable battery 112 may comprise a case 113 supporting a plurality of battery cells 115 therein. Preferably, the battery cells 115 have sufficient capacity to operate the lights 102 for approximately one hour or more. In the event of depletion, the battery 112 can be quickly and easily replaced with a fresh battery 112.

The replaceable battery 112 may have an external power button 114 operative to control the lights 102 and potentially other functions of the device 100. The case 113 may widen at a proximal end to encase a charging circuitry PCB 116. The distal end of the removable battery 112 and an interior end of the battery compartment 111 may define coaxial electrical connectors 117 (such as a C13/C14 connector) which align by virtue of the case 113 fitting within the confines of the battery compartment 111.

Further preferably, the distal end of the battery 112 and the interior end of the battery compartment 111 define a twist lock mechanism 118 to prevent dislodgement of the battery 112 from the battery compartment 111. With this mechanism, the battery 112 may be pushed in slightly and twisted to release the twist lock mechanism 118 and remove the battery 112.

The frames 107 may be annular to accommodate the battery compartment 111. With reference to FIG. 6, the central frame 107B and the lateral frame 107C may define an especially large interior diameter to accommodate the relatively large battery compartment 111. These frames 107 rigidly interface the battery compartment 111 and the tubular case 101, properly supporting the battery cells 115 (which may be relatively heavy) contained within the battery compartment 111.

The device 100 may comprise an electronics compartment 119 longitudinally aligned with the battery compartment 111, as shown in FIG. 1. The electronics compartment 119 may be relatively smaller in width and length compared to the battery compartment 111. Various power supply and control electronic PCBs may be installed within the electronics compartment 119.

In embodiments, a controller is installed within the electronics compartment 119 configured to control the lights 102. The controller may interface with an accelerometer configured to determine the orientation of the device 100 and, therefore, independently control the operation of the lights 102. For example, in one mode of operation, the controller may operate only the uppermost lights 102, such as those contacting the skin when the body is rolled over the device 100 across a floor surface.

In embodiments, the controller may interface with a wireless transceiver (such as a Bluetooth transceiver) configured to receive control instructions, including selecting an operational mode of the device 100. The operational mode may be specified by a target muscle group, with the controller controlling the lights 102 accordingly. For example, for deeper tissue massage, such as the glutes, the controller may increase light intensity for enhanced penetration compared to shallower tissue massage, such as for the triceps.

The controller may also be configured to transmit data via the wireless transceiver. The controller may measure dosage based on the operational duration of the lights 102 and transmit dosage information (such as light exposure measured in joules) via the wireless transceiver to a recipient electronic device, such as a mobile phone with a software application installed for interfacing with the device 100.

In embodiments, a vibrator may be installed within the electronics compartment 119 to oscillate the tubular case 101. The vibrator may comprise an electric motor turning an eccentric flywheel. The controller may control the speed of the electric motor and, therefore, the frequency of the vibration.

The lateral frame 107A may similarly engage the electronics compartment 119, although it may have a smaller internal diameter compared to those for the battery compartment 111.

The device 100 may be configured to direct cooling airflow through the device to dissipate heat, especially generated by high-intensity red or infrared lights 102. In this regard, the device may comprise an intake grille 120 and an exhaust grille 121. The exhaust grille may be defined by the battery 112. A fan contained within the electronics compartment 119 may rotate an impeller 122 at the intake grille 120. In the embodiment shown, the impeller 122 is a centrifugal impeller. With reference to FIG. 6, the electronics compartment 119 may comprise side vents 123 to facilitate the escape of airflow, which traverses the lights 102 and frames 107 and exits through the exhaust grille 121. The battery case 113 may comprise vents to allow the entry and escape of airflow via the exhaust grille 121.

In an exemplary method of use, the massage therapy device 100 is first powered by inserting the removable battery 112 into the internal battery compartment 111 via the distal end of the device 100. The battery 112 is aligned so that the coaxial electrical connectors 117 engage correctly, and is then secured by rotating the twist lock mechanism 118 to prevent dislodgement during operation. The external power button 114, located on the removable battery 112, is actuated by the user to activate the device 100.

Once activated, the controller housed within the electronics compartment 119 initiates operation of the lights 102. These lights 102, preferably comprising red or infrared LEDs mounted on the support rods 108, emit therapeutic light in the range of approximately 600 to 1100 nm. The light is projected radially through the flat-faced lenses 106, which press against the internal surface of the transparent tubular case 101. The light passes through both the rigid tube 104 and the non-rigid sleeve 103 and is directed onto the user's skin when the tubular case 101 is brought into contact with the body.

The user may place the massage therapy device 100 on a floor surface and roll their body over it, such that the tubular case 101 rotates beneath the targeted muscle group. Alternatively, the user may manually roll the device 100 against the desired area using the hands or arms. As the device 100 is rolled, pressure is applied to the skin-contacting non-rigid sleeve 103, which deforms slightly to provide ergonomic comfort and effective transmission of therapeutic light and mechanical stimulation.

In embodiments where a vibrator is provided within the electronics compartment 119, the controller may also activate the electric motor to drive the eccentric flywheel, thereby oscillating the tubular case 101. This vibrational effect enhances the mechanical stimulation delivered by the rolling action of the device 100. The controller may also interface with an accelerometer to detect the orientation of the device 100, enabling selective control of the lights 102 based on which portion of the device 100 is in contact with the user.

In some modes of operation, the controller may adjust the intensity or pattern of light emission according to a selected muscle group. These modes may be specified through a wireless connection to a remote electronic device via a transceiver, such as a Bluetooth module. Dosage data, based on light output duration and intensity, may also be transmitted to the user's device for monitoring purposes.

To dissipate heat generated during operation, the device 100 may draw ambient air through the intake grille 120 by operation of a centrifugal impeller 122 located within the electronics compartment 119. Airflow is directed through the internal framework past the lights 102 and is expelled through the exhaust grille 121, which may be defined in part by vents formed in the battery case 113. This airflow path helps regulate internal temperature, maintaining safe operating conditions and prolonging component lifespan.

Once the therapy session is complete, the user may deactivate the massage therapy device 100 by pressing the power button 114. The removable battery 112 may be withdrawn by unlocking the twist lock mechanism 118 and pulling the battery 112 from the battery compartment 111 for recharging or replacement.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A massage therapy device comprising:
a tubular case;
lights configured to emit light from the tubular case; and
an internal framework supporting the tubular case.

2. The device according to claim 1, wherein the lights are configured to emit therapeutic light within the range of 600 to 1100 nm and radially from the tubular case.

3. The device according to claim 1, wherein the tubular case is designed to be rolled against the body for deep tissue massage.

4. The device according to claim 1, wherein the tubular case comprises a transparent non-rigid sleeve made of silicone enveloping a transparent rigid tube made of polycarbonate.

5. The device according to claim 1, wherein the internal framework comprises a series of frames arranged along the length of the device, the frames supporting longitudinal rigid support rods having LEDs mounted thereon and electrically connected to a power supply.

6. The device according to claim 5, wherein the frames define aligned notches supporting the support rods, and comprise longitudinally oriented flanges resistant to bending.

7. The device according to claim 5, wherein at least one end cap defines sockets into which ends of the support rods are inserted and engaged.

8. The device according to claim 1, further comprising lenses interfacing the lights and the tubular case, the lenses being flat-faced to press flat against an interior surface of the tubular case.

9. The device according to claim 1, further comprising an internal battery compartment and a removable battery configured to insert into the battery compartment.

10. The device according to claim 9, wherein the removable battery comprises an external power button, and wherein the removable battery and the battery compartment define coaxial electrical connectors and a twist lock mechanism to prevent dislodgement.

11. The device according to claim 9, wherein the battery compartment occupies most of the width and length of the device.

12. The device according to claim 9, further comprising an electronics compartment longitudinally aligned with the battery compartment.

13. The device according to claim 12, further comprising a controller installed within the electronics compartment and configured to control the lights.

14. The device according to claim 13, wherein the controller is configured to adjust at least one of the intensity and operation of the lights according to a mode of operation, the mode being optionally specified by a target muscle group.

15. The device according to claim 13, wherein the controller interfaces with an accelerometer to determine the orientation of the device and independently control the lights accordingly.

16. The device according to claim 13, wherein the controller interfaces with a wireless transceiver configured to receive control instructions and transmit dosage data to a remote electronic device.

17. The device according to claim 16, wherein the dosage data is based on at least one of operational duration and intensity of the lights.

18. The device according to claim 1, further comprising a vibrator configured to oscillate the tubular case, the vibrator comprising an electric motor turning an eccentric flywheel.

19. The device according to claim 18, wherein the vibrator is installed within a separate electronics compartment adjacent to the battery compartment.

20. The device according to claim 1, wherein the tubular case comprises an intake grille and an exhaust grille at opposite ends thereof, and an impeller adjacent to the intake grille to generate a cooling airflow through the device.
